(19) United States
(12) Patent Application Publication
(10) Pub. No.: US 2025/0046919 A1
(43) Pub. Date: Feb. 6, 2025

(54) BATTERY ASSEMBLY AND METHOD FOR ASSEMBLING A BATTERY ASSEMBLY

(71) Applicant: LASERAX INC., Québec (CA)

(72) Inventors: Stéphane MELANCON, Québec (CA); Catherine VEILLEUX, Québec (CA); Jean-Michaël DESCHENES, Lévis (CA); Alex FRASER, Québec (CA)

(21) Appl. No.: 18/713,261

(22) PCT Filed: Nov. 29, 2022
(86) PCT No.: PCT/CA2022/051741

§ 371 Date: May 24, 2024

Related U.S. Application Data
(60) Provisional application No. 63/283,680, filed on Nov. 29, 2021.

(51) Int. Cl. H01M 50/131; B23K 26/352; H01M 10/613; H01M 10/6554; H01M 50/103; H01M 50/105; H01M 50/107

(52) U.S. Cl. CPC H01M 50/131; B23K 26/355; H01M 10/613; H01M 10/6554; H01M 50/103; H01M 50/105; H01M 50/107

(57) ABSTRACT

There is described a battery assembly. The battery assembly generally having a first battery component having a first surface; a second battery component having a second surface facing the first surface; a gap extending between the first and second surfaces; an interface material extending in the gap and connecting the first and second surfaces to one another; the first surface having first patterned features laser-formed on a portion of the first surface, the first patterned features defining a first textured portion having a first effective surface area greater than an initial surface area of the portion of the first surface prior to the formation of the first patterned features.

### BACKGROUND

Battery cells, such as lithium-ion batteries, are commonly used to power a wide range of systems, such as portable electronics, electric vehicles, and medical equipment. They are generally available in various shapes and configurations, such as cylindrical cells, prismatic cells or pouch cells. In some systems such as electric vehicles, battery cells are packaged into battery modules and/or battery packs to provide the desired range and power to the electric vehicle.

Packaging a plurality of battery cells into a battery pack for an electric vehicle presents challenges, notably in terms of the mechanical/structural integrity of the battery pack and thermal management of the battery cells contained in the battery pack. Mechanical/structural integrity of the battery pack is designed for providing a battery pack that is robust and capable of withstanding shocks and vibrations. Thermal management of the battery pack is designed for providing an extended lifespan to the battery cells, improve protection against overheating, and thereby improving the reliability, safety and range of the electric vehicle.

Therefore, improvements are desirable in the way battery components are formed into battery assemblies in order to provide better mechanical/structural integrity and/or thermal management to the battery packs including these battery assemblies.

### SUMMARY

In accordance with a first aspect of the present disclosure, there is provided a battery assembly comprising: a first battery component having a first surface; a second battery component having a second surface facing the first surface; a gap extending between the first and second surfaces; an interface material extending in the gap and connecting the first and second surfaces to one another; the first surface having first patterned features formed on a portion of the first surface, the first patterned features defining a first textured portion having a first effective surface area greater than an initial surface area of the portion of the first surface prior to the formation of the first patterned features.

Further in accordance with the first aspect of the present disclosure, the second surface can for example have second patterned features formed on a portion of the second surface, the second patterned features defining a second textured portion having a second effective surface area greater than an initial surface area of the portion of the second surface prior to the formation of the second patterned features.

Still further in accordance with the first aspect of the present disclosure, the first patterned features can for example be laser formed using a patterning beam of a laser system, the patterning beam having a laser energy greater than an ablation threshold of a material forming the first surface.

Still further in accordance with the first aspect of the present disclosure, the first patterned features defining the first textured portion can for example be selectively shaped for adhesive bonding of the interface material to the first surface.

Still further in accordance with the first aspect of the present disclosure, the first patterned features defining the first laser textured portion can for example be selectively shaped for thermal transfer between the first and second battery components through the interface material.

Still further in accordance with the first aspect of the present disclosure, the first battery component can for example be a battery cell, and the second battery component is a thermal plate.

Still further in accordance with the first aspect of the present disclosure, the first surface can for example be defined by a can of the battery cell, the first surface being part of an outer face of the can, the first textured portion extending over the outer face of the can.

Still further in accordance with the first aspect of the present disclosure, the can may for example have a thickness, and each of the first patterned features has a feature size being up to about 20% of the thickness of the can.

Still further in accordance with the first aspect of the present disclosure, each of the first patterned features can for example have a feature size being up to about 10% of a thickness of the interface material.

Still further in accordance with the first aspect of the present disclosure, each of the first patterned features can for example have a feature size ranging between about 0.01 and about 0.12 mm.

Still further in accordance with the first aspect of the present disclosure, the first patterned features can for example define at least one of a micro-grid, an array of micro-dimples, and parallel micro-grooves on the first surface.

Still further in accordance with the first aspect of the present disclosure, there is provided a battery pack comprising the battery assembly described above.

In accordance with a second aspect of the present disclosure, there is provided a method for assembling a battery assembly, the battery assembly having a first battery component having a first surface, and a second battery component having a second surface, the method comprising: using a laser system, directing a patterning beam to the first surface, the patterning beam having a laser energy greater than an ablation threshold of a material forming the first surface, said directing including selectively forming first patterned features having a first texture being different from an initial texture of the portion of the first surface prior to said forming; and connecting the first and second battery components to one another using an interface material disposed between the first patterned features of the first surface and the second surface.

Further in accordance with the second aspect of the present disclosure, said directing can for example further include directing the patterning beam to the second surface, the patterning beam having a laser energy greater than an ablation threshold of a material forming the second surface, said directing including selectively forming second patterned features defining a second texture being different from an initial texture of the portion of the second surface prior to said forming.

Still further in accordance with the second aspect of the present disclosure, the method can for example further comprise, after selectively forming the first patterned features and prior to said connecting, applying a coating to the first patterned features.

Further in accordance with the second aspect of the present disclosure, the first patterned features can for example have an effective surface area greater than an effective surface area of the portion of the first surface prior to said forming.

In accordance with a third aspect of the present disclosure, there is provided a battery assembly including a first battery component including a first surface, a second battery component including a second surface facing the first surface, a gap extending between the first and second surfaces, an interface material extending in the gap and being connected to the first and second surfaces, and at least one of the first and second surfaces includes patterned features selectively formed by a patterning beam of a laser system on at least a portion of the surface, the patterning beam having a laser energy greater than an ablation threshold of a material forming the surface, the patterned features defining a laser textured portion of the surface having an effective surface area greater than the effective surface area of the surface prior to the formation of the patterned features.

In accordance with a fourth aspect of the present disclosure, there is provided a method for forming a battery assembly including providing a first battery component including a first surface, providing a second battery component including a second surface, providing a laser system configured to output a patterning beam to at least one of the first and second surfaces, the patterning beam having a laser energy greater than an ablation threshold of a material forming the at least one of the first and second surfaces, selectively forming patterned features on at least one of the first and second surfaces with the patterning beam, the patterned features defining a laser textured portion on the at least one of the first and second surfaces being different from an initial texture of the at least one of the first and second surfaces, and connecting the first and second battery components using an interface material disposed between the first surface and the second surface.

In accordance with a fifth aspect of the present disclosure, there is provided a battery component including a substrate forming a surface including at least one feature selectively formed by at least one patterning beam of a laser system on at least a portion of the surface, the patterning beam having a laser energy greater than an ablation threshold of the substrate forming the surface of the substrate, the at least one feature defining a laser textured portion of the surface, and the laser textured portion having an effective surface area greater than the effective surface area of the surface prior to the formation of the at least one feature.

In accordance with a sixth aspect of the present disclosure, there is provided a method for selectively texturing a surface of a battery component, the method including providing a battery component including a substrate forming the surface, the surface having an initial texture, providing at least one laser system configured to output at least one patterning beam to the surface of the substrate, the patterning beam having a laser energy greater than an ablation threshold of the substrate forming the surface of the substrate, and selectively forming at least one feature on at least a portion of the surface of the substrate with the patterning beam, the at least one feature defining a laser textured portion on the surface being different from the initial texture.

Many further features and combinations thereof concerning the present improvements will appear to those skilled in the art following a reading of the instant disclosure.

### DESCRIPTION OF THE FIGURES

Reference is now made to the accompanying drawings, in which:

FIG. 1A is a schematic view of an example of a battery assembly, shown with three battery cells in thermal connection with a thermal pad, in accordance with one or more embodiments;

FIG. 1B is a schematic view of another example of a battery assembly, shown with three battery cells in thermal connection with a liquid-dispensed gap filler, in accordance with one or more embodiments;

FIG. 2A is a perspective view of an example of a prismatic battery cell, in accordance with one or more embodiments;

FIG. 2B is a perspective view of an example of a battery assembly including prismatic battery cells such as the prismatic battery cell of FIG. 2A, in accordance with one or more embodiments;

FIG. 2C is a perspective view of an example of a battery pack including battery assemblies such as the battery assembly of FIG. 2B, in accordance with one or more embodiments;

FIG. 3A is a perspective, longitudinal cross-sectional view of an example of a cylindrical battery cell, in accordance with one or more embodiments;

FIG. 3B is a perspective view of an example of a pouch battery cell, in accordance with one or more embodiments;

FIG. 4A is a perspective, schematic view of an example of a laser texturing process for forming patterned features on a surface using a patterning beam, in accordance with one or more embodiments;

FIG. 4B is a top plan view of an example of a laser textured portion of a surface including an array of micro-dimples, in accordance with one or more embodiments;

FIG. 4C is a top plan view of another example of a laser textured portion of a surface including micro-grooves, in accordance with one or more embodiments;

FIG. 4D is a top plan view of another example of a laser textured portion of a surface including a micro-grid, in accordance with one or more embodiments;

FIG. 5A is a perspective view of an example of a cylindrical battery cell, shown with a casing having a surface of an initial texture, in accordance with one or more embodiments;

FIG. 5B is a perspective view of an example of a cylindrical battery cell, shown with a casing having a surface including a laser textured portion, in accordance with one or more embodiments;

FIG. 6A is a perspective view taken from a top of the cylindrical battery cell of FIG. 5B, with the base thereof being exposed to a patterning beam, in accordance with one or more embodiments;

FIG. 6B is an enlarged, perspective view of a sidewall of the cylindrical battery cell of FIG. 6A during a laser texturing process, in accordance with one or more embodiments;

FIG. 6C is an enlarged, perspective view of the sidewall of the cylindrical battery cell of FIG. 6B, in accordance with one or more embodiments;

FIGS. 7A and 7B are schematic, cross-sectional views of examples of a laser textured portion of a surface and an interface material connected to the surface, in accordance with one or more embodiments;

FIG. 8A is a chart illustrating the pull-off strength required for cohesive failure and adhesive failure on different samples including a laser textured portion and/or using different interface materials, in accordance with one or more embodiments;

FIG. 8B is a chart illustrating the lap shear strength required for cohesive failure and adhesive failure on different samples including a laser textured portion and/or using different interface materials, in accordance with one or more embodiments;

FIG. 9A is a schematic view of different battery assemblies including different battery components having different surface roughness, in accordance with one or more embodiments;

FIG. 9B is a schematic view of a battery assembly including battery components and an interface material disposed between the battery components, in accordance with one or more embodiments;

FIG. 9C is a chart illustrating the heat transfer vs thermal conductibility in battery assemblies having different configurations, in accordance with one or more embodiments; and

FIG. 10 is a flowchart of an example of a method for assembling a battery assembly, in accordance with one or more embodiments.

### DETAILED DESCRIPTION

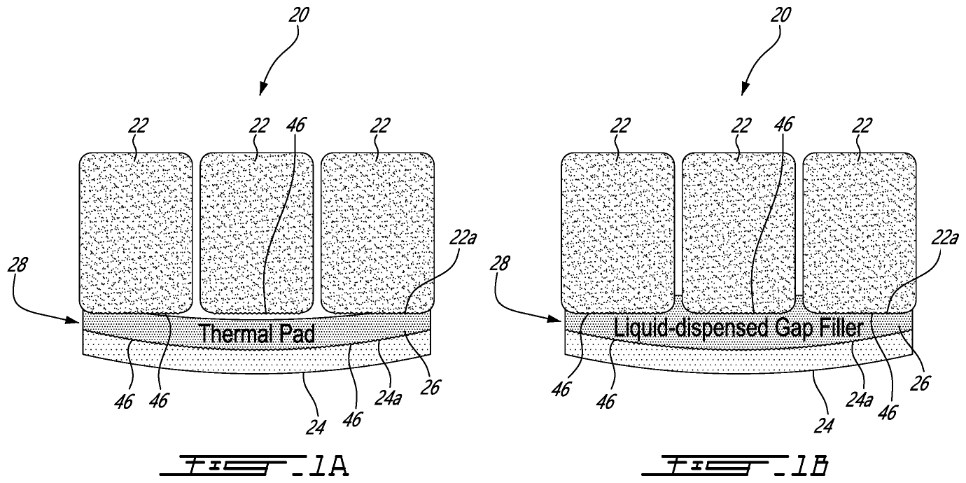

FIG. 1A shows an example of a battery assembly 20 including battery components including three cylindrical battery cells 22, a thermal plate 24, and an interface material 26 extending in a gap 28 defined by surfaces 22a and 24a of the battery cells 22 and the thermal plate 24, respectively. The thermal plate 24 is a battery component part of a thermal management system capable of extracting heat from the battery cells 22 and/or providing heat to the battery cells 24. For instance, the thermal plate 24 can be a heatsink or a cooling plate, depending on the embodiment. In this example, the interface material 26 is a thermal pad. The interface material 26 is exposed to the surfaces 22a and 24a which face each other. As will be described further below, the interface material 26 connects the battery cells 22 to the thermal plate 24 and allows for thermal transfer between the battery cells 22 and the thermal plate 24. The interface material 26, which is connected to the battery cells 22 and the thermal plate 24, may form a structurally rigid battery assembly 20 when the interface material 26 is made of a relatively rigid material. The surfaces 22a and 24a are typically formed of metallic material such as steel, aluminium alloys, nickel, copper, stainless steel or a combination thereof.

FIG. 1B shows another example of a battery assembly 20. In this specific embodiment, the interface material 26 is a liquid-dispensed gap filler. The liquid-dispensed gap filler can be a paste, a silicon-based material, an adhesive or any other suitable thermal interface material. Again, the interface material 26 connects the battery cells 22 to the thermal plate 24 and allows for thermal transfer between the battery cells 22 and the thermal plate 24. The interface material 26, which is liquid-dispensed in this example, is capable of better conforming to the surface 22a of each battery cell 22 and to the surface 24a of the thermal plate 24. As such, the liquid-dispensed gap filler can fill the gap 28 more effectively than the thermal pad shown in FIG. 1A. Depending on the nature of the liquid-dispensed gap filler, thermal conductibility between the battery cells 22 and the thermal plate 24 is expected to be increased because of the additional contact surface between the interface material 26 and the battery cells 22. Moreover, it is contemplated that the interface material 26, although being liquid-dispensed, can also provide for a structurally rigid battery assembly 20, provide for thermal transfer between the surfaces 22 and 24a, and/or provide both a structurally rigid battery assembly 20 and thermal transfer between the surfaces 22a and 24a.

In this disclosure, there is described a battery assembly having a first battery component with a first surface, and a second battery component with a second surface facing the first surface. In some embodiments, the first battery component is the battery cell 22 and the first surface is the surface 22a. In some embodiments, the second battery component is the thermal plate 24 and the second surface is the surface 24a. As discussed above, a gap such as the gap 28 extends between the first and second surfaces of a respective one of the first and second battery components. An interface material extends in the gap and connects the first and second surfaces to one another. Examples of the interface material can include, but are not limited to, the thermal pad, a liquid-dispensed gap filler, an adhesive, or a combination thereof. As will be described in further details below, the first surface has first patterned features 46 that are laser-formed on a portion of the first surface. As such, the first patterned features 46 define a first textured portion having a first effective surface area which is greater than an initial surface area of the portion of the first surface prior to the formation of the first patterned features 46. The first patterned features 46 can be formed on either one or both of the surfaces 22a and 24a. Indeed, in some embodiments, the second surface has second patterned features 46 formed on a portion of the second surface. The second patterned features 46 defining a second textured portion having a second effective surface area which is greater than an initial surface area of the portion of the second surface prior to the formation of the second patterned features 46. The greater effective surface area of the first and second surfaces, provided by the first and second patterned features, respectively, can enhance the bonding or other connection performed by the interface material extending in the gap. As described below, the first and second patterned features 46 are laser-formed using a patterning beam of a laser system. In such embodiments, the patterning beam has a laser energy which is greater than an ablation threshold of a material forming the first and/or second surface.

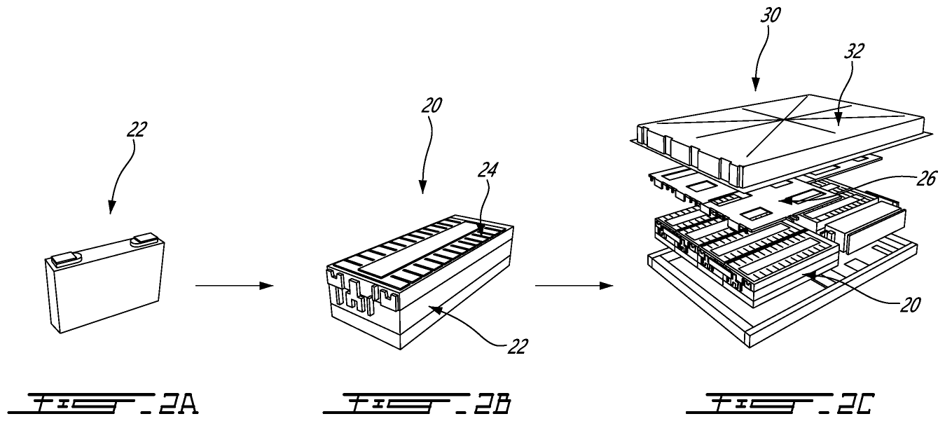

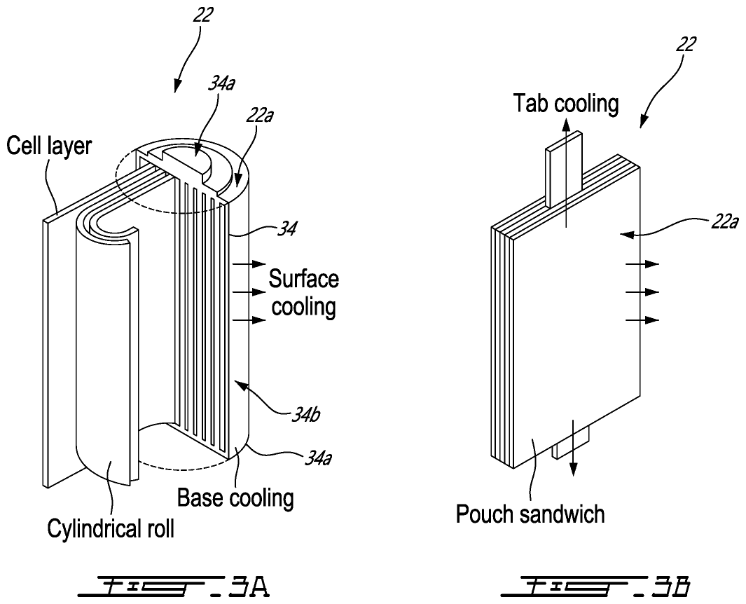

In FIG. 2A, a single prismatic battery cell 22 is shown. In some embodiments, the first and second battery components can both be part of a single battery cell 22. In FIG. 2B, several of such prismatic battery cells 22 are assembled into a battery assembly 20 which includes thermal plates 24 disposed above and below the battery cells 22. An interface material 26 (not shown) is disposed between the battery cells 22 and the thermal plates 24 to allow thermal transfer between the battery cells 22 and the thermal plates 24, and in some cases provide structural rigidity to the battery assembly 20. In some embodiments, the first battery component can be part of a battery cell 22 and the second battery component can be an adjacent battery cell 22 or another component of the battery assembly 20. In FIG. 2C, several of such battery assemblies 20 are put into a battery pack 30. Again, interface material 26 can be disposed between the battery assemblies 20 and components of the battery pack 30, such as cooling plates 32. The interface material 26 fills one or more gaps extending between components of the battery pack 30, and allows for thermal transfer between the battery assemblies 20 and cooling plates 32. In some embodiments, the first battery component can be part of a battery cell or a battery assembly, and the second battery component can be part of another component of the battery pack 30.

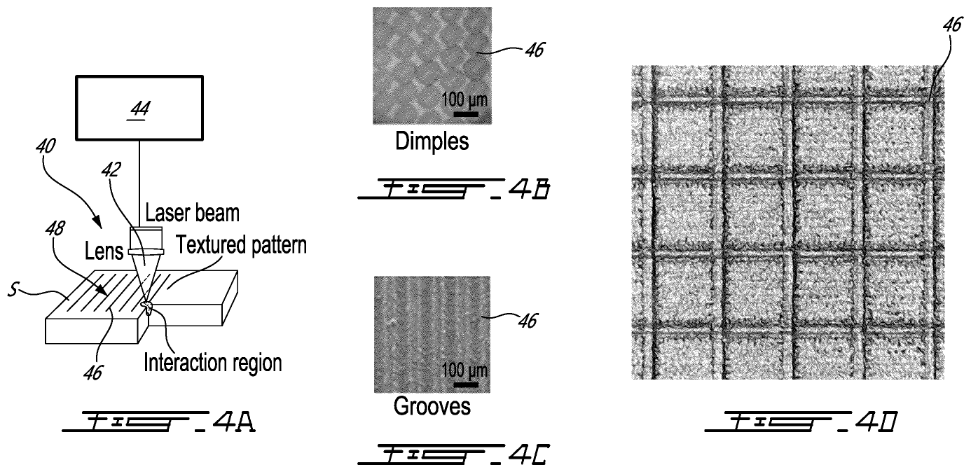

Referring to FIG. 3A, a cylindrical battery cell 22 is depicted. The battery cell 22 includes cell layers and cylindrical rolls of materials suited for providing the chemical reaction responsible for storing and supplying electrical energy. The battery cell 22 has a can 34 defining the surface 22a. The can 34 has top and bottom bases 34a and a sidewall 34b which are part of the surface 22a. Thermal transfer to the environment and materials surrounding the battery cell 22 is effected through the bases 34a and sidewall 34b. In some embodiments where the cylindrical battery cell 22 is a lithium-ion battery, the can 34 can be composed of Ni-coated steel due to the excellent chemical resistance and corrosion protection provided by nickel to the steel. In another embodiment, the can 34 can be composed of stainless steel due to the excellent chemical resistance and corrosion protection provided by stainless steel.

Referring to FIG. 3B, a pouch battery cell 22 is illustrated. The pouch battery cell 22 has a surface 22a through which thermal transfer can be effected.

For clarity, the following description makes reference to the cylindrical battery cell 22 presented in FIGS. 1A, 1B and 3A, but other shapes and types of battery cells can be used in the context of the present technology, such as the prismatic battery cell of FIG. 2A and the pouch battery cell the FIG. 3B described above. Battery assemblies 20 can take different shapes and configuration and involve a variety of components, and the following description is intended to describe only a few examples of battery assemblies 20 including components such as cylindrical battery cells 22 and thermal plates 24. However, other battery components are contemplated to be used in the context of the present technology.

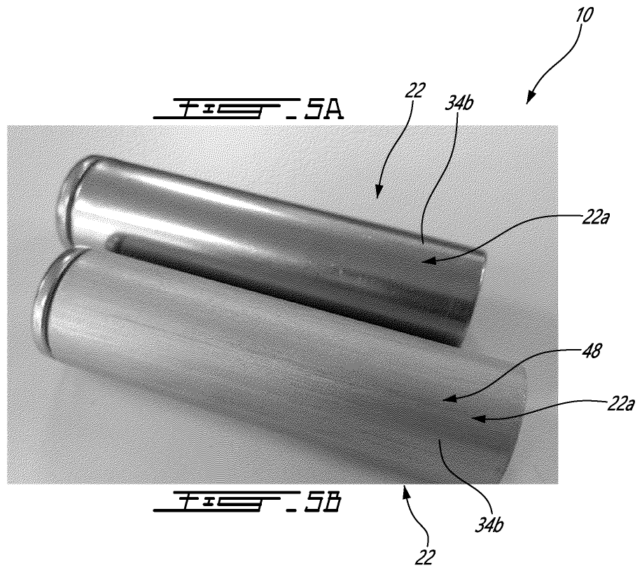

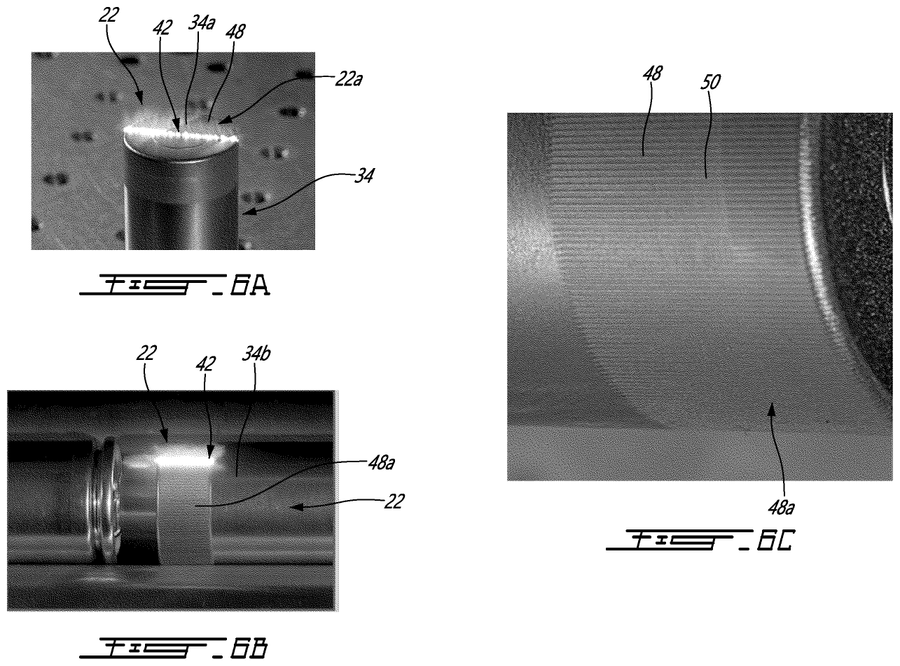

Referring to FIG. 4A, a laser texturing process 40 is schematically represented. A patterning beam 42 of a laser system 44 is directed to a surface S. The patterning beam 42 has a laser energy being greater than an ablation threshold of the material forming the surface S. As the material forming the surface S is ablated when exposed to the patterning beam 42, patterned features 46 are formed on the surface S. As shown, the patterned features 46 define a laser textured portion 48 of the surface S. The patterned features 46 provide that the effective surface area of the laser textured portion 48 of the surface S is greater than the effective surface area of the surface S prior to the formation of the patterned features 46. In other words, the laser texturing process 40 forms patterned features on the surface S to increase the effective surface area of the surface S. It is noted that patterned features have a texture which is different from an initial texture of the portion of the surface S prior to the forming.

The laser texturing process 40 can have advantages compared to other processes that can be used to increase the effective surface area of a surface, such as chemical abrasives or grit blasting. These advantages can include, and are not limited to, no abrasive media is required, operative costs and maintenance are lower compared to other techniques, and no contaminants are exposed to the surface. The laser texturing process 40 can also be configured to provide for a wide range of patterned features 46 (having personalized shape, size, etc.) with high accuracy and repeatability.

Referring to FIGS. 4B-4D, patterned features 46 resulting from different laser texturing processes 40 are shown. In FIG. 4B, an array of micro-dimples is shown with a dimple diameter of about 100 μm. In FIG. 4C, parallel micro-grooves are shown with each micro-groove having a width of about 100 μm. In FIG. 4D, a micro-grid is shown. In the following description, the expression “feature size” is meant to refer to the typical size of an individual feature forming the patterned features provided by the laser texturing process 40. The feature size may refer to a depth, a width or a length depending on the shape of the individual feature. It is contemplated that combinations of patterned features 46 can be present on a same laser textured portion 48, and that other configurations of patterned features (size, shape, depth, height, etc.) than the ones shown in the figures are contemplated.

Referring to FIG. 5A, a cylindrical battery cell 22 is shown with the surface 22a of the sidewall 34b having an initial texture. The initial texture can be relatively smooth, with a relatively low surface roughness and a relatively low effective surface area. FIG. 5B shows another cylindrical battery cell 22 having the surface 22a of the sidewall 34b including a laser textured portion 48 provided by a laser texturing process 40 such as the one described above.

Referring to FIGS. 3A, 4A and 5B, the sidewall 34b of the can 34 forming the surface 22a has been exposed to the patterning beam 42 of the laser system 44 to selectively form patterned features 46 on the surface 22a upon ablation of some of the material forming the surface 22a of the sidewall 34b, and thus forming a laser textured portion 48, in order to increase the effective surface area of the surface 22a compared to the effective surface area of the initial texture. In some embodiments, the can 34 has a thickness ranging between 250 and 300 μm, and each of the patterned features 46 has a feature size being up to about 20% of the thickness of the can 34 in order to not significantly affect the structural properties of the can 34. In some embodiments, each of the patterned features 46 has a feature size being up to about 10% of a thickness of the interface material 26. In some embodiments, the thickness of the interface material 26 can be determined as the average width of the gap 28 between the surfaces 22a and 24a. In yet some other embodiments, each of the patterned features 46 has a feature size ranging between about 0.01 and 0.12 mm. The shape and configuration of the patterned features 46 can be selected to improve thermal transfer, improve adhesive bonding to the interface material 26, or both.

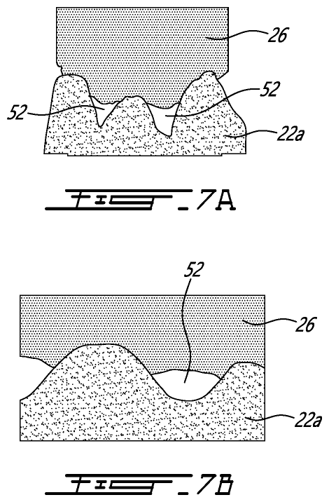

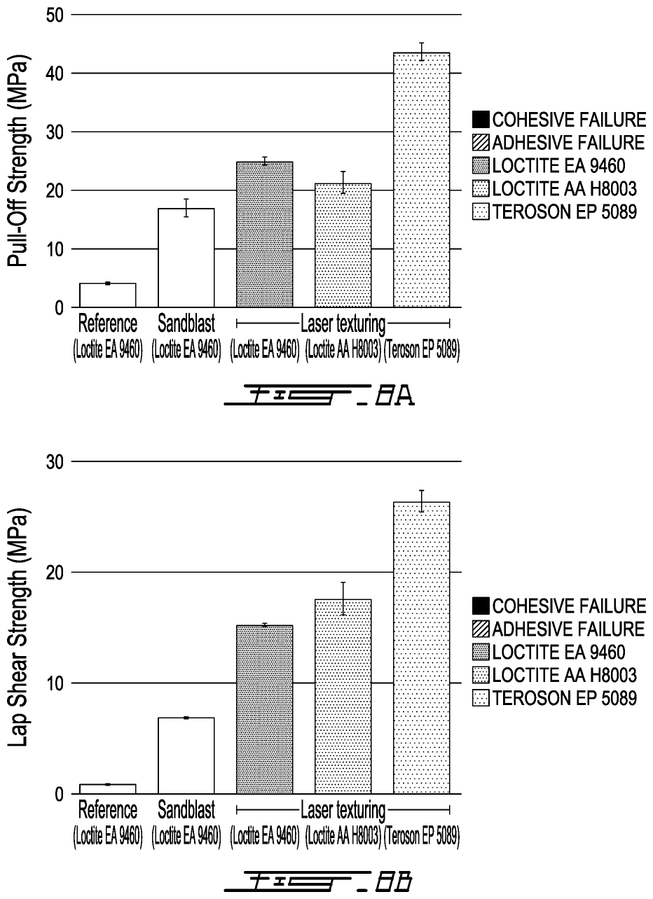

Referring to FIG. 6A, the base 34a of the can 34 of the battery cell 22 is exposed to the patterning beam 42 of the laser system 44 to selectively form patterned features 46 on the surface 22a upon ablation of some of the material forming the surface 22a of the base 34a. In FIG. 6B, a portion of the sidewall 34b is further exposed to the patterning beam 42 of the laser system 44 to provide another laser textured portion 48a being different from the laser textured portion 48 shown in FIG. 5B. FIG. 6C shows the textured portion 48a including the patterned features 46 of laser textured portion 48 and grooves 50 formed on the sidewall 34b. Laser textured portion 48a has an effective surface area greater than laser textured portion 48. Laser textured portion 48a can extend otherwise on the surface 22a of the battery cell 22 in other embodiments.

Although not illustrated in the figures, other components of the battery assembly 20 can also be subjected to the laser texturing process 40 in order to increase the effective surface area of at least some portion of their surface. For example, surface 24a of the thermal plate 24 shown in FIGS. 1A and 1B can be subjected to the laser texturing process 40 in order to increase the effective surface area of at least some portion of surface 24a.

Referring to FIGS. 1A, 1B and 6A, having the laser textured portion 48 (and/or laser textured portion 48a) on the surface 22a of the battery cell 22 and/or on the surface 24a of the thermal plate 24 increases the adhesive bonding of the interface material 26 thereto. Since there is more surface area on which the interface material 26 can adhere, there can be an enhanced bonding between the surfaces 22a and 24a and the interface material 26 compared to surfaces 22a and 24a not being subjected to laser texturing process 40. It is contemplated that the shape and configuration of patterned features 46 formed on the surfaces 22a and 24a can be selected to further enhance the adhesive bonding with the interface material 26. Moreover, the formation of the patterned features 46 may form compounds (such as metallic oxides) that may further improve the chemical bond between the interface material 26 and the surface 22a.

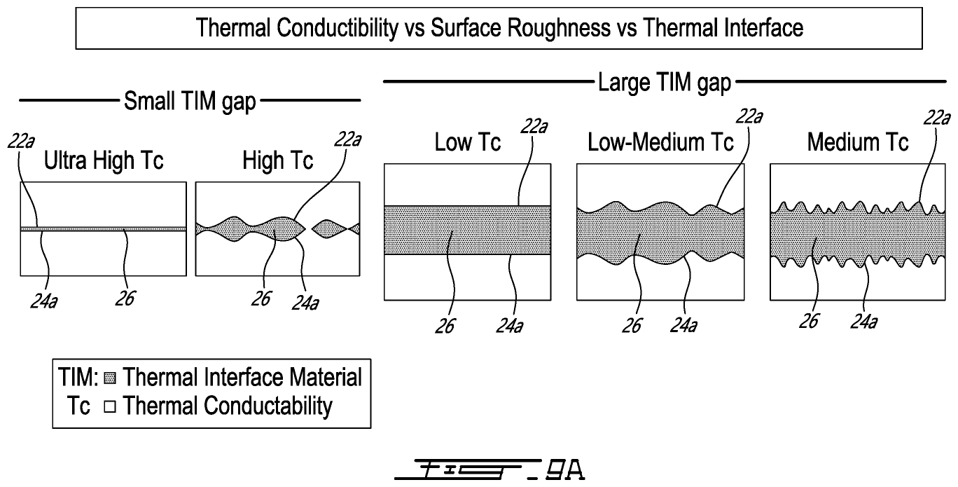

It is contemplated that the laser textured portion 48 can be selectively formed to reduce the likelihood that the interface material 26 does not fully contact the surface 22a. Referring to FIG. 7A, voids 52 between the interface material 26 and the surface 22a may be a defect and cause cohesive failure between the interface material 26 and the surface 22a. Viscosity of the interface material 26 is also a parameter to be considered to reduce the number of voids 52 between the interface material 26 and the surface 22a. Referring to FIG. 7B, voids 52 may also entrap air between the interface material 26 and the surface 22a, and thus reduce the thermal conductibility between the battery cell 22 and the interface material 26. Furthermore, it has been determined that regardless which pattern features 46 are formed on the surface 22a, the surface 22a should be fully treated (i.e., no gap in between each laser pass) to ensure that no surface is left untouched and therefore generates a defect in the bond between the surface 22a and the interface material 26.

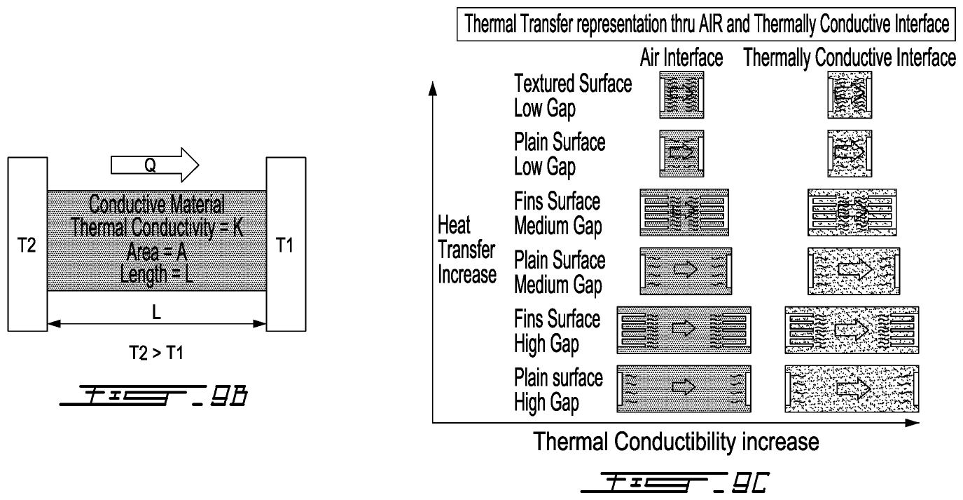

The chart presented in FIG. 8A illustrates that surfaces having been subjected to the laser texturing process 40 have improved pull-off strength performance over a reference, untreated surface (1^{st} bar) and a sandblasted surface (2^{nd} bar) in both cohesive failure and adhesive failure. This improvement is shown with three different types of interface material 26. The chart presented in FIG. 8B illustrates that surfaces having been subjected to the laser texturing process 40 have improved lap shear strength performance over a reference, untreated surface (1^{st} bar) and a sandblasted surface (2^{nd} bar) in both cohesive failure and adhesive failure. This improvement is also shown with three different types of interface material 26.

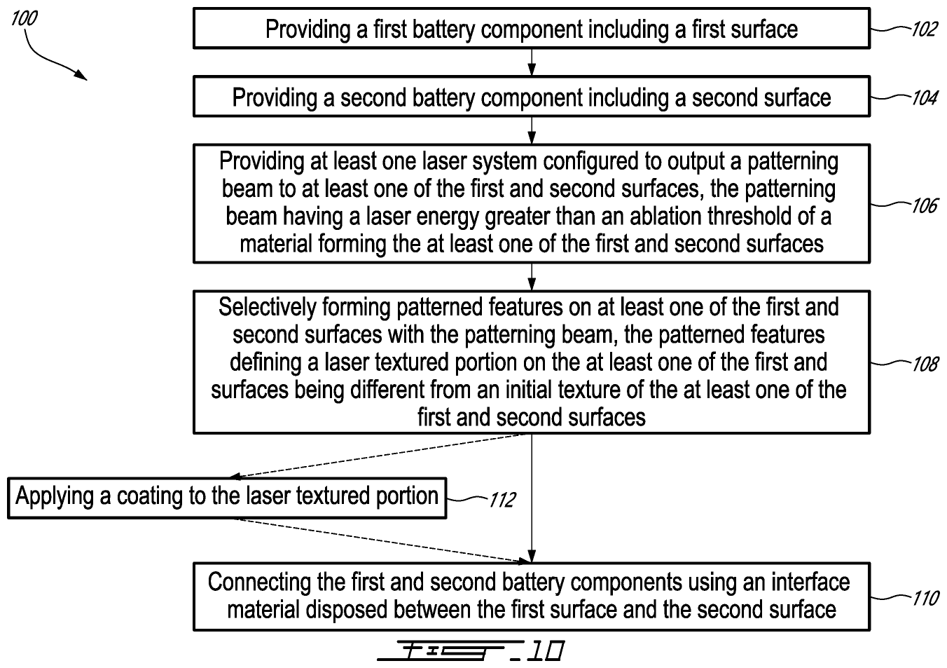

Referring now to FIGS. 9A to 9C, the thermal transfer between the battery cell 22 and the thermal plate 24 will be described in more details. When the surfaces 22a and 24a are spaced apart by a relatively small gap 28 (1^{st} and 2^{nd} pictures of FIG. 9A), the thermal conductibility through the interface material 26 is relatively high because due to the relatively small thickness of the interface material 26. However, when the surfaces are spaced apart by a relatively large gap (3^{rd}, 4^{th} and 5^{th} pictures of FIG. 9A), the thermal conductivity of the interface material 26 becomes significant and may reduce the thermal conductibility between the surfaces 22a and 24a. The interface material 26 acts like a thermal insulator between the surfaces 22a and 24a. In order to increase the thermal conductibility between the surfaces 22a and the interface material 26, and also from the interface material 26 to the surface 24a, forming laser textured portions 48 on the surfaces 22a and/or 24a increases their effective surface area, thus increasing the contact area between each surface and the interface material 26. The patterned features 46 act as fins on a thermal plate and increase the overall thermal conductibility between the surfaces 22a and 24a. Referring to FIG. 9B, increasing A (i.e., the effective surface area) has the effect of increasing the conductive heat transfer between the media T2 and T1 spaced apart by distance L through the conductive material connected therebetween. FIG. 9C also illustrates that for medium-sized and large-sized gaps, having a “fin surface” increases the thermal conductibility between the two media.

In some cases, the gap 28 (FIGS. 1A and 1B) between the battery cell 22 and the thermal plate 24 can be of a few millimeters in a battery assembly 20. Such a gap 28 is way larger than the feature size of the patterned featured 46 formed by the laser texturing process 40 described above. In some conditions, a gap 28 of 1 mm is about ten times larger than the feature size. In order to mitigate the effects of the interface material 26 having a reduced thermal conductivity compared to the materials forming the surfaces 22a and 24a, defining a laser-textured portion 48 on one or both surfaces 22a and 24a can improve the thermal conductibility between the surfaces 22a and 24a.

It is reasonably predicted from scientific literature that by increasing the effective surface area in at least some portions of the surface of battery cell 22 and thermal plate 24 exposed to the interface material 26, the thermal conductibility from one battery component to another may increase. In this respect, the following publications are incorporated-by-reference herein in their entirety: Lu, L., Zhang, Z., Guan, Y., & Zheng, H. (2018). Enhancement of Heat Dissipation by Laser Micro Structuring for LED Module. Polymers, 10(8), 886. https://doi.org/10.3390/polym10080886; Ayer, M. (2010) A Study of the Influence of Surface Roughness on Heat Transfer. Worcester Polytechnic Institute.

Therefore, in applications such as the battery pack 30 (FIG. 2C) including several battery cells (FIG. 2A) that need to be thermally managed to increase their lifespan and reliability and to improve protection against overheating, having a portion of the surface 22a of the battery cell 22 with relatively high effective surface area might improve thermal management of the battery pack 30.

Furthermore, because adhesive bonding is improved when the interface material 26 is disposed on laser textured portion(s) 48 of the surfaces 22a and/or 24a, there is an improved reliability of the thermal path between the battery cell 22 and the thermal plate 24. In other words, because the adhesive bonding provided by the interface material is improved, there is a reduced likelihood of cohesive and/or adhesive failure of the interface material 26, and thus there is a reduced likelihood of a crack forming within the interface material 26 and/or between the interface material 26 and one of the surfaces 22a and 24a. Such a crack may form an air barrier thereby reducing the thermal conductibility between the surfaces 22a and 24a. There is therefore a synergetic effect of having surfaces with relatively high effective surface area in contact with an interface material because, as described above, (i) the adhesive bonding can be improved, (ii) the thermal conductibility through the material interface 26 can be improved, and/or (iii) the reliability of the thermal path between the battery components can be improved.

Referring to FIGS. 1A, 1B and 10, there is provided a method 100 for assembling the battery assembly 20. The battery assembly has a first battery component with a first surface, and a second battery component with a second surface. In some embodiments, the first battery component is a battery cell 22 and the second battery component is a thermal plate 24. In some other embodiments, the first battery component is a thermal plate 24 and the second battery component is a battery cell 22. At block 102, the method 100 includes a step of providing the first battery component. At block 104, the method 100 includes a step of providing the second battery component. At block 106, the laser system 44 configured to output the patterning beam 42 to the first surface, the second surface or both. The patterning beam 42 has a laser energy greater than an ablation threshold of a material forming the at least one of the first and second surfaces. At block 108, the patterning beam is directed to either one of the first and second surfaces. This step includes selectively forming patterned features on the first and/or second surfaces with the patterning beam 42. The patterned features 46 define a first texture being different from an initial texture of the first and/or second surfaces. At block 110, the first and second battery components are connected to one another using an interface material 26 disposed between the first surface and the second surface. When the interface material 26 is an adhesive, the interface material 26 bonds the first surface 22a and the surface 24a to each other. The method 100 further includes, at block 112, an optional step of applying a coating to the first texture or more specifically onto at least a portion of the patterned features. This step can be performed, for example, in cases where a delay occurs between the steps of blocks 108 and 110 which can lead to the formation of undesired compounds on the surfaces 22a and 24a.

As can be understood, the examples described above and illustrated are intended to be exemplary only. The scope is indicated by the appended claims.

1. A battery assembly comprising:
a battery cell having a first surface;
a second battery component having a second surface facing the first surface;
a gap extending between the first and second surfaces;
an interface material extending in the gap and connecting the first and second surfaces to one another;
the first surface having first patterned features formed on a portion of the first surface, the first patterned features defining a first textured portion having a first effective surface area greater than an initial surface area of the portion of the first surface prior to the formation of the first patterned features.

2. The battery assembly of claim 1, wherein the second surface has second patterned features formed on a portion of the second surface, the second patterned features defining a second textured portion having a second effective surface area greater than an initial surface area of the portion of the second surface prior to the formation of the second patterned features.

3. The battery assembly of claim 1, wherein the first patterned features are laser formed using a patterning beam of a laser system, the patterning beam having a laser energy greater than an ablation threshold of a material forming the first surface.

4. The battery assembly of claim 1, wherein the first patterned features defining the first textured portion are selectively shaped for adhesive bonding of the interface material to the first surface.

5. The battery assembly of claim 1, wherein the first patterned features defining the first laser textured portion are selectively shaped for thermal transfer between the battery cell and the battery components through the interface material.

6. The battery assembly of claim 1, wherein the battery component is one of: a thermal plate, a part of the battery cell, an adjacent battery cell and another component of the battery assembly.

7. The battery assembly of claim 6, wherein the first surface is defined by a can of the battery cell, the first surface being part of an outer face of the can, the first textured portion extending over the outer face of the can.

8. The battery assembly of claim 7, wherein the can has a thickness, and each of the first patterned features has a feature size being up to about 20% of the thickness of the can.

9. The battery assembly of claim 1, wherein each of the first patterned features has a feature size being up to about 10% of a thickness of the interface material.

10. The battery assembly of claims 1, wherein each of the first patterned features has a feature size ranging between about 0.01 and about 0.12 mm.

11. The battery assembly of claim 1, wherein the first patterned features define at least one of a micro-grid, an array of micro-dimples, and parallel micro-grooves on the first surface.

12. A battery pack comprising the battery assembly of claim 1.

13. A method for assembling a battery assembly, the battery assembly having a battery cell having a first surface, and a battery component having a second surface, the method comprising:
using a laser system, directing a patterning beam to the first surface, the patterning beam having a laser energy greater than an ablation threshold of a material forming the first surface, said directing including selectively forming first patterned features having a first texture portion being different from an initial texture portion of the portion of the first surface prior to said forming; and
connecting the battery cell and the battery components to one another using an interface material disposed between the first patterned features of the first surface and the second surface.

14. The method of claim 13 wherein said directing includes directing the patterning beam to the second surface, the patterning beam having a laser energy greater than an ablation threshold of a material forming the second surface, said directing including selectively forming second patterned features defining a second texture being different from an initial texture of the portion of the second surface prior to said forming.

15. The method of claim 13, further comprising, after selectively forming the first patterned features and prior to said connecting, applying a coating to the first patterned features.

16. The method of claim 13, wherein the first patterned features have an effective surface area greater than an effective surface area of the portion of the first surface prior to said forming.
